(19) United States
(12) Patent Application Publication
(10) Pub. No.: US 2026/0152242 A1
(43) Pub. Date: Jun. 4, 2026

(54) PRE-TENSIONING SYSTEM FOR A COIL SPRING SUSPENSION PIN BOX

(71) Applicant: Lippert Components, Inc., Elkhart, IN (US)

(72) Inventors: John SHOTWELL, Edwardsburg, MI (US); Dominic LAYNE, South Bend, IN (US); Borivoj KROBOT, La Porte, IN (US)

(21) Appl. No.: 19/407,587

(22) Filed: Dec. 3, 2025

Related U.S. Application Data
(60) Provisional application No. 63/727,463, filed on Dec. 3, 2024.

(51) Int. Cl. B62D 53/08

(52) U.S. Cl. CPC B62D 53/0842

(57) ABSTRACT

A pin box includes a frame member, a jaw member pivotally attached to the frame member and pivotable between an expanded position and a contracted position, and a spring secured between the frame member and the jaw member. The frame member defines an upper limit stop for the jaw member, and the frame member defines a lower limit stop for the jaw member.

### CROSS-REFERENCES TO RELATED APPLICATIONS

This application claims the benefit of U.S. Provisional Ser. No. 63/727,463, filed Dec. 3, 2024, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to a pin box for coupling a fifth-wheel trailer to a fifth-wheel hitch on a tow vehicle and, more particularly, to a pin box configured to absorb and/or dampen shocks that might be transmitted between a trailer and a tow vehicle.

A pin box on a fifth-wheel trailer connects the trailer to the tow vehicle. The pin box typically houses a kingpin, which locks into the fifth-wheel hitch mounted in the bed of a truck. The pin box's primary function is to provide a secure connection between the trailer and tow vehicle, allowing the trailer to pivot smoothly during turns. The pin box also helps distribute the weight of the trailer, ensuring stability while towing.

Some pin boxes are equipped with shock absorption to reduce vibrations and improve ride comfort. Pin boxes without shock absorption can lead to mechanical issues, compromised safety, and a significantly less comfortable towing experience. Shock-absorption in pin boxes is often used to mitigate these issues and extend the life of both the trailer and tow vehicle.

### SUMMARY

The pin box of the described embodiments has hard stop features on the upper and lower jaws or frame members of the pin box, which are used to adjust and preset upper and lower limits of the pin box coil spring suspension. The upper jaw or frame member of the pin box has a built-in hard stop or bump-out portion that abuts a surface of the interior of the pin box when the coil spring is compressed to prevent the spring and shock from compressing too far.

The lower jaw or frame member has at least one bolt-on hard stop for setting a pre-load of the spring and the angle of the lower jaw in the open position relative to lower portion of the upper jaw member. A longer hard stop can be used to increase the pre-load of the spring and decrease the open angle of the lower jaw, which increases the force from the spring. In some embodiments, there are two bolt-on hard stops, one on each side of the lower jaw. Each bolt-on hard stop includes two block portions, one including an aperture for receiving a bolt to secure the hard stop with the lower jaw. The bolted block abuts the lower portion of the upper jaw member when the coil spring is in an extended or uncompressed state.

In an exemplary embodiment, a pin box includes a frame member, a jaw member pivotally attached to the frame member and pivotable between an expanded position and a contracted position, and a spring secured between the frame member and the jaw member. The frame member defines an upper limit stop for the jaw member, and the frame member defines a lower limit stop for the jaw member.

The upper limit stop of the frame member may include a detent facing the jaw member, and the jaw member may engage the detent in the contracted position. The jaw member may include an internal cover plate, and the internal cover plate may engage the detent on the contracted position. The spring may extend through the internal cover plate.

The lower limit stop of the frame member may include a tab member disposed in proximity to the jaw member. The pin box may further include a stop block secured to the jaw member, and the stop block may be positioned to engage the tab member in the expanded position. A length of the stop block may be selected according to a desired range of motion for the jaw member. A pre-load may be applied to the spring. In this context, the pre-load may be adjustable according to a length of the stop block.

A kingpin may be secured to the jaw member. The spring may be a coil spring, and a longitudinal axis of the kingpin may be aligned with a center of the coil spring.

The pin box may also include a gas strut connected between the frame member and the jaw member that biases the jaw member toward the expanded position.

The frame member may include a first spring seat, and the jaw member may include a second spring seat, where the spring engages the first and second spring seats.

In another exemplary embodiment, a pin box includes a frame member, a jaw member pivotally attached to the frame member and pivotable between an expanded position and a contracted position, a spring secured between the frame member and the jaw member, and a stop block secured to the jaw member. The stop block engages the frame member in the expanded position, and a pre-load is applied to the spring that is being adjustable based on a length of the stop block.

### BRIEF DESCRIPTION OF THE DRAWINGS

These and other aspects and advantages will be described in detail with reference to the accompanying drawings, in which:

FIG. 1 is a perspective view of the pin box according to the described embodiments showing the kingpin and stop blocks;

FIG. 2 is a top perspective view of the pin box;

FIG. 3 is an alternative perspective view of the pin box;

FIG. 4 shows the pivot axle for the jaw member of the pin box;

FIG. 5 shows the pin box in a contracted position;

FIG. 6 shows the pin box in an expanded position; and

FIGS. 7-10 show a variation for an application to a gooseneck hitch.

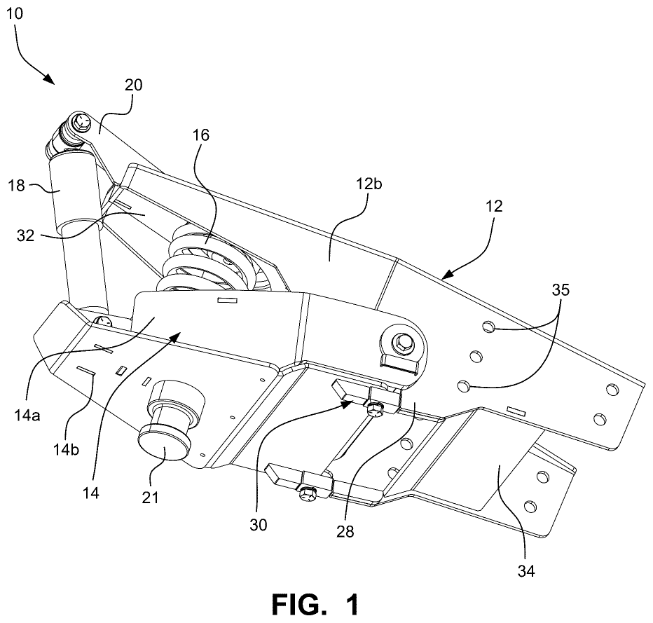

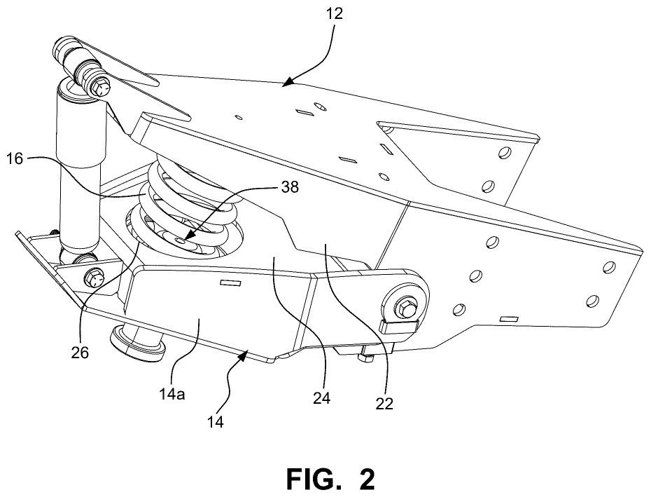

### DETAILED DESCRIPTION

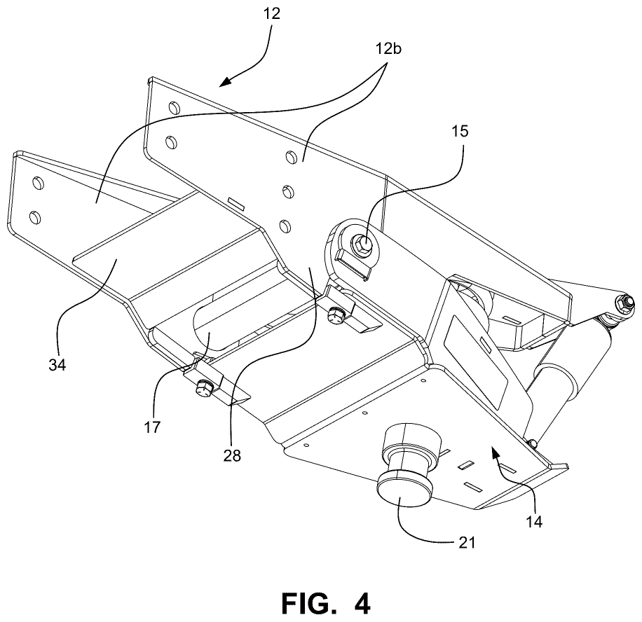

A pin box couples a fifth-wheel trailer to a fifth-wheel hitch on a tow vehicle. With reference to the figures, the pin box 10 of the described embodiments includes a frame member 12 and a jaw member 14 pivotally attached to the frame member 12. With reference to FIG. 4, the jaw member 14 may be pivotally secured to the frame member 12 via connectors 15 across a pivot axis 17.

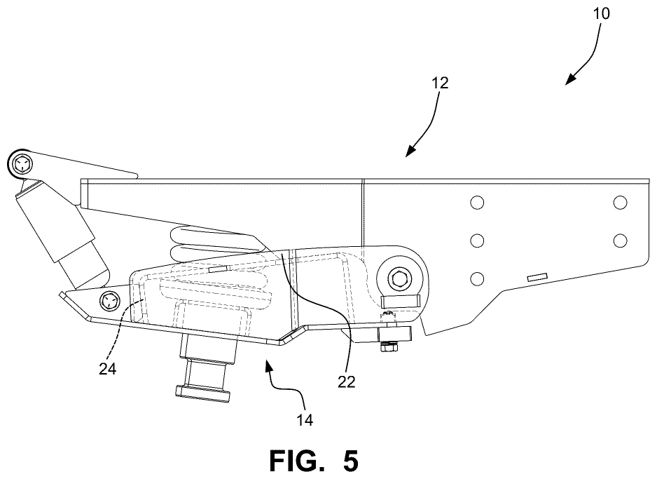

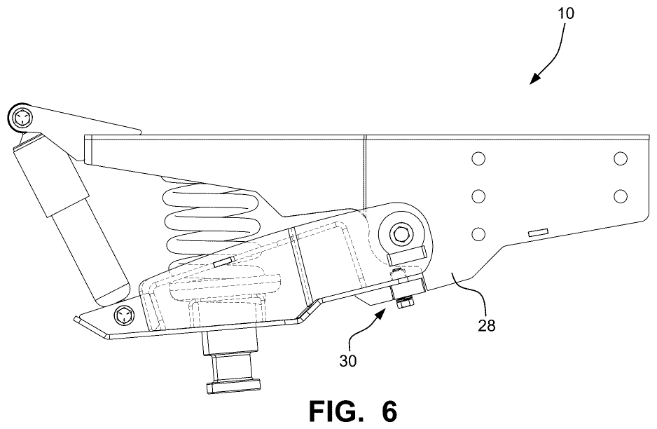

The jaw member 14 is pivotable between an expanded position (FIG. 6) and a contracted position (FIG. 5). A spring 16 such as a coil spring is secured between the frame member 12 and the jaw member 14. A dampening device 18, such as a gas shock absorber or the like, is connected between a dampener tab 20 of the frame member 12 and a forward end of the jaw member 14. The dampening device 18 biases the jaw member 14 toward the expanded position. The spring 16 and the dampening device 18 work together to absorb and/or dampen shocks transmitted between a trailer and a tow vehicle. In other embodiments, the dampening device may be pressured or biased hydraulicly or by a resilient structural member.

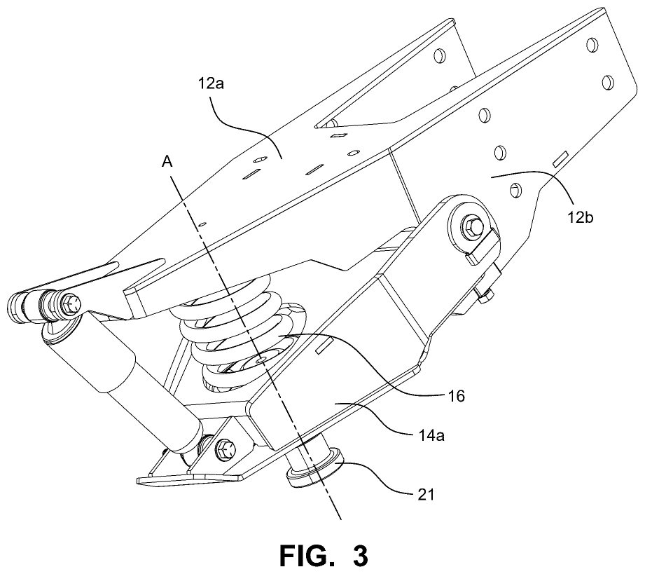

A kingpin 21 is secured to the jaw member 14. As shown in FIG. 3, in some embodiments, a longitudinal axis of the kingpin 21 may be aligned with a center of the spring 16. See line A in FIG. 3.

The frame member 12 includes a detent 22, and the jaw member 14 may include an internal cover plate 24, which effectively defines a box-frame structure for the jaw member 14. The internal cover plate 24 includes an aperture 26 through which the spring 16 extends. The detent 22 defines an upper limit stop for the jaw member 14. With reference to FIG. 5, in the contracted position, the detent 22 of the frame member 12 engages the internal cover plate 24 of the jaw member 14. The frame member 12 thus defines an upper limit stop for the jaw member 14 via the detent 22 engaging the internal cover plate 24. The frame member 12 may include alternative structure for defining an upper limit stop.

The frame member 12 may also include a tab member 28 disposed in proximity to the jaw member 14 that defines a lower limit stop for the jaw member 14. A stop block 30 may be secured to the jaw member 14 such that the stop block 30 is positioned to engage the tab member 28 in the expanded position. See FIG. 6. The stop block 30 may be constructed as a bolt-on member for setting the maximum angle of the jaw member 14 in the expanded position. In some embodiments, bolt-on stop block 30 includes two block portions, one including an aperture for receiving a bolt to secure the stop block 30 with the jaw member 14. The bolted block 30 abuts the tab member 28 of the frame member 12 when the coil spring 16 is in an extended or uncompressed state.

The bolt-on block 30, by limiting a position of the jaw member 14, also serves to set a pre-load of the spring 16. The length of the stop block 30 is selected according to a desired range of motion for the jaw member 14. That is, with reference to FIG. 6, if it was desired to reduce the range of the jaw member 14 and also increase the pre-load on the spring 16, a longer stop block 30 can be secured to the jaw member 14 so that the stop block 30 would engage the tab member 28 with a smaller range than that shown in FIG. 6. On the other hand, a shorter stop block 30 can expand the range of motion for the jaw member 14.

The frame member 12 includes a top plate 12a and sidewalls 12b. An internal plate 32 is connected between the sidewalls 12b for structural reinforcement. The spring 16 extends through an opening in the internal plate 32. In some embodiments, the spring 16 is seated in a first spring seat 36 of the frame member and a second spring seat 38 of the jaw member. A rear portion of the frame member 12 includes the pivot axis 17 and a support plate 34 connected between the sidewalls 12b (see FIG. 4). The sidewalls 12b of the frame member 12 include apertures 35 for securing the pin box 10 to a trailer frame or the like.

The jaw member 14 is constructed of side strips 14a secured to the internal cover plate 24 and a bottom wall 14b. The kingpin 21 is fixed to the bottom wall 14b of the jaw member 14. The frame member 12 and the jaw member 14 may be formed respectively into unitary members with welded parts.

FIG. 5 shows the pin box 10 in the contracted position. The detent(s) 22 of the frame member 12 engage the internal cover plate 24 of the jaw member 14. FIG. 6 shows the pin box 10 in the expanded position. The stop block(s) 30 engage the tab member 28 of the frame member 12.

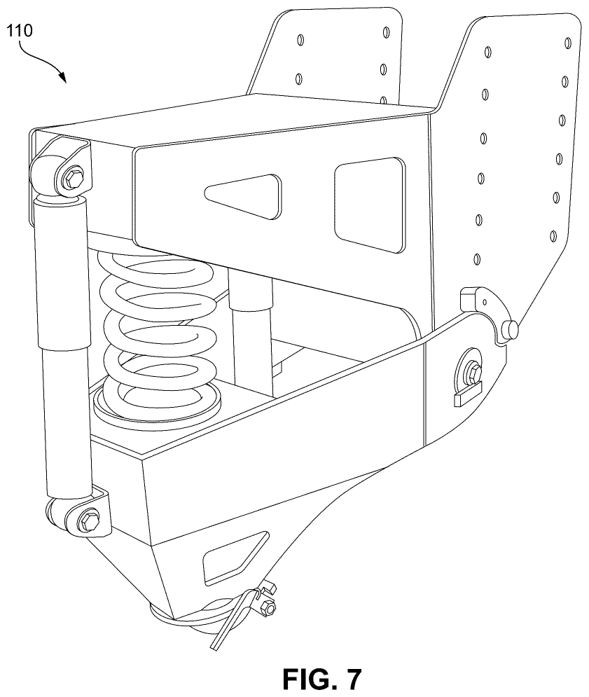

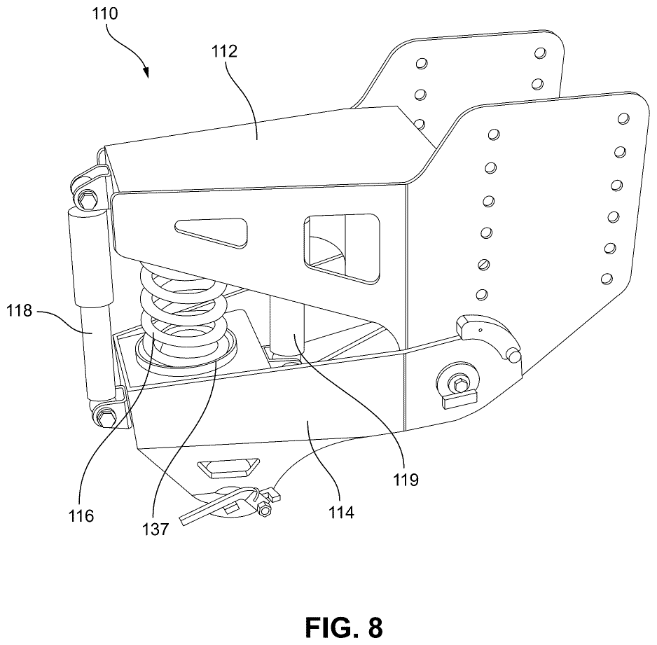

Although an application of the pin box has been described in the context of a fifth wheel hitch, with reference to FIGS. 7-10, a version can be envisioned for a gooseneck hitch 110. In this variation, the kingpin is replaced with a ball socket. Similar to the pin box embodiment, the assembly includes one pivot point, a spring 116, and a dampener/gas shock absorber 118. The gooseneck hitch 110 may include a second gas shock absorber 119, as shown in FIGS. 8-10 as being disposed behind the coil spring and disposed between the interior of the frame member 112 and the interior of the jaw member 114. In some embodiments, the second gas shock absorber 119 may act as the upper stop limit for jaw member 114 and may lack a detent. A detent (not shown) may additionally or alternatively be included in a gooseneck hitch embodiment.

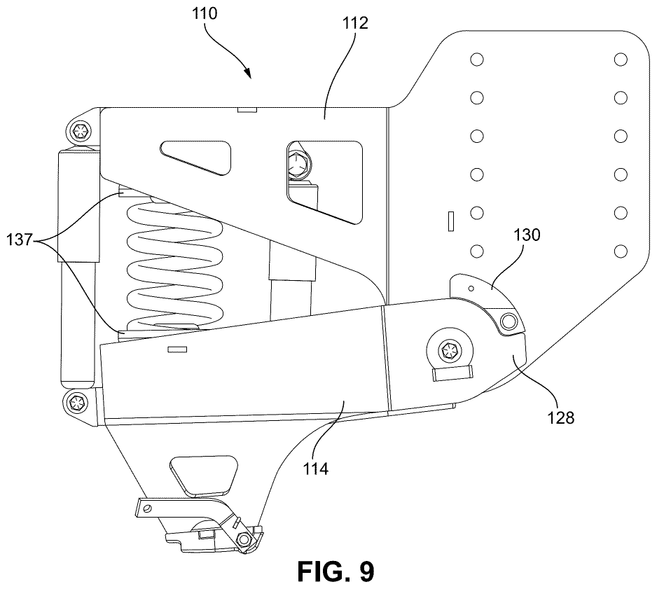

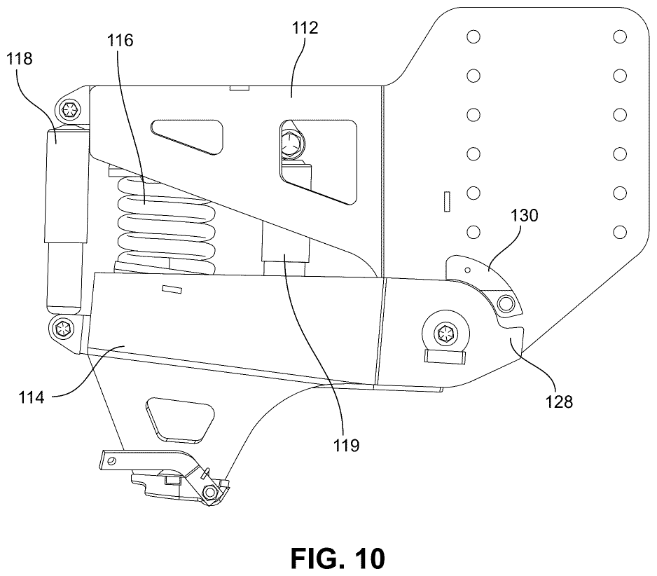

The gooseneck hitch 110 includes a stop block 130 to set the maximum angle of the jaw member 114 by limiting a position of the jaw member and sets a pre-load of the spring 116, similar to the pin box embodiment. The stop block 130 as shown in FIGS. 9-10 bolts onto the frame member 112 instead of the jaw member 114, but may be bolted to the jaw member in other embodiments. As shown, the jaw member 114 includes a tab member 128 that interacts with the stop block 130 and acts as a lower limit stop for the jaw member 114 when in the expanded or uncompressed position. Similar to previous embodiments, the stop block 130 may include two block portions for selecting the length of the stop block according to a desired range of motion for the jaw member 114.

The spring 116 as shown is secured to upper and lower elevated spring seats 137 that are secured to the frame member 112 and the jaw member 114.

The pin box of the described embodiments utilizes hard stop features on the upper and lower jaws or frame members of the pin box, which are used to adjust and preset upper and lower limits of the pin box coil spring suspension. The bolt-on hard stop on the jaw member sets a pre-load of the spring and the angle of the jaw member in the expanded position. The range of motion and pre-load can be adjusted by changing the length of the bolt-on hard stop.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A pin box comprising:
a frame member;
a jaw member pivotally attached to the frame member and pivotable between an expanded position and a contracted position; and
a spring secured between the frame member and the jaw member,
wherein the frame member defines an upper limit stop for the jaw member, and wherein the frame member defines a lower limit stop for the jaw member.

2. A pin box according to claim 1, wherein the upper limit stop of the frame member comprises a detent facing the jaw member, and wherein the jaw member engages the detent in the contracted position.

3. A pin box according to claim 2, wherein the jaw member comprises an internal cover plate, and wherein the internal cover plate engages the detent on the contracted position.

4. A pin box according to claim 3, wherein the spring extends through the internal cover plate.

5. A pin box according to claim 1, wherein the lower limit stop of the frame member comprises a tab member disposed in proximity to the jaw member, the pin box further comprising a stop block secured to the jaw member, and wherein the stop block is positioned to engage the tab member in the expanded position.

6. A pin box according to claim 5, wherein a length of the stop block is selected according to a desired range of motion for the jaw member.

7. A pin box according to claim 5, wherein a pre-load is applied to the spring.

8. A pin box according to claim 7, wherein the pre-load is adjustable according to a length of the stop block.

9. A pin box according to claim 1, further comprising a kingpin secured to the jaw member.

10. A pin box according to claim 9, wherein the spring is a coil spring, and wherein a longitudinal axis of the kingpin is aligned with a center of the coil spring.

11. A pin box according to claim 1, further comprising a gas strut connected between the frame member and the jaw member, the gas strut biasing the jaw member toward the expanded position.

12. A pin box according to claim 1, wherein the frame member comprises a first spring seat, and wherein the jaw member comprises a second spring seat, the spring engaging the first and second spring seats.

13. A pin box comprising:
a frame member;
a jaw member pivotally attached to the frame member and pivotable between an expanded position and a contracted position;
a spring secured between the frame member and the jaw member; and
a stop block secured to the jaw member, wherein the stop block engages the frame member in the expanded position, and wherein a pre-load is applied to the spring, the pre-load being adjustable based on a length of the stop block.

14. A pin box according to claim 13, wherein the frame member comprises a tab member defining a lower limit stop, and wherein the stop block is positioned to engage the tab member in the expanded position.

15. A pin box according to claim 13, wherein the frame member comprises a detent facing the jaw member that defines an upper limit stop for the jaw member, the jaw member engaging the detent in the contracted position.

16. A pin box according to claim 13, further comprising a kingpin secured to the jaw member.

17. A pin box according to claim 16, wherein the spring is a coil spring, and wherein a longitudinal axis of the kingpin is aligned with a center of the coil spring.

18. A pin box according to claim 13, further comprising a gas strut connected between the frame member and the jaw member, the gas strut biasing the jaw member toward the expanded position.
